(19) United States
(12) Patent Application Publication
(10) Pub. No.: US 2024/0020438 A1
(43) Pub. Date: Jan. 18, 2024

(54) SHOE UPPER DESIGN MODEL GENERATING METHOD, SYSTEM AND NON-TRANSITORY COMPUTER READABLE STORAGE MEDIA

(71) Applicant: YU JUNG CHANG TECHNOLOGY CO., LTD., New Taipei City (TW)

(72) Inventors: Wei-Hsiang TSAI, New Taipei City (TW); CHIN-YU CHEN, New Taipei City (TW); CHUN-HENG LIN, New Taipei City (TW); CHIH-PENG CHEN, New Taipei City (TW); FONG-YI SYU, New Taipei City (TW)

(21) Appl. No.: 18/303,831

(22) Filed: Apr. 20, 2023

(30) Foreign Application Priority Data
Jul. 12, 2022 (TW) 111126188

(51) Int. Cl. G06F 30/20; G06F 30/10

(52) U.S. Cl. CPC G06F 30/20; G06F 30/10; G06F 2113/12

(57) ABSTRACT

This invention provides a shoe upper design model generating method, system and non-transitory computer readable storage media, including steps of providing a 2D mapping boundary, providing a 3D upper, performing a flattening algorithm on the 3D upper with respect to the 2D mapping boundary, constructing a 2D upper boundary, creating an upper design drawing on the 2D upper boundary, intersecting the 2D upper boundary and the 2D mapping boundary to form a 2D upper design area and mapping grids in the 2D upper design area onto grids in the 3D upper, thereby obtaining an upper design model containing the mapping relation between the 2D upper design area and the 3D upper. Accordingly, the upper pattern making time and cost can be saved, and the distortion and deformation in the process of 2D-3D conversion can be reduced, thus the completed 2D upper design drawing can be used in production process directly.

### BACKGROUND OF THE INVENTION

### 1. Technical Field

The present invention relates to a digital shoe upper design method, and in particular, to a shoe upper design model generating method, system and non-transitory computer-readable storage media.

### 2. Description of the Related Art

Traditionally, in the beginning of the shoes making, the shoe designers show their ideas by draft or computer-aided design (CAD) tools. The completed shoe upper design drawings are submitted to a pattern maker to create the two dimensional (2D) shoe pattern matching with the design drawings from the designer. The 2D shoe pattern then can be used in the following sample making stage. Finally, the shoe upper made from the 2D shoe pattern is combined with the shoe sole, in order to complete the production of a pair of shoes. Based on such conventional process, with the rapid development of CAD tools, there are numerous types of CAD software available in the market capable of assisting designers to perform shoe upper design, and the reference information of materials and lines, etc. necessary for the design process is integrated in the technical package for submission to a pattern maker along with the digital drawing files. Accordingly, the pattern maker is able to perform digital pattern making via the use of CAD tools.

During the aforementioned development process, the design drawings created by a designer are typically 2D design drawings illustrating the perspective views or parallel projection views of shoe; however, the 2D shoe pattern created by a pattern maker is on the basis of the flattened last draft. There are always differences between the design drawings from the designer and the 2D shoe pattern created by the pattern maker. Accordingly, repetitive discussions and confirmations between the designer and pattern maker are required, and numerous different versions of physical shoe upper samples are also created during the process. Consequently, the process can be time and labor consuming, which also leads to the increase of cost.

Despite that the number of physical shoe upper samples can be reduced by CAD tools, it is still challenging to convert the design drawings created by the designer into 2D shoe pattern that can be used for production. For example, the shoe upper is made of multiple layers or diverse materials with different thickness, the various types of stitching method may be utilized to combine materials, and deformation may also occur during the process of converting the design drawing to the 2D shoe upper pattern, all of such factors can cause the shoe upper to be unfit to the shoe last. Consequently, repetitive revision of the design drawings, the 2D shoe upper pattern and shoe upper samples are required before the production process, causing hassles during the shoe upper design process.

### BRIEF SUMMARY OF THE INVENTION

In view of the above, an objective of the present invention is to provide a shoe upper design model generating method, system and non-transitory computer readable storage media, capable of constructing a three-dimensional (3D) perspective shoe upper model and 2D plane shoe pattern mapping with each other, thus allowing the designer and pattern maker to make modification and to cooperate directly on the shoe upper model. In addition, the 2D shoe pattern is able to match with the physical last draft, such that the 2D shoe pattern can be provided for use in the subsequent production process.

To achieve the aforementioned objective, one preferred embodiment the present invention provides a shoe upper design model generating method, comprising the following steps: using a processor to provide a 2D mapping boundary, the 2D mapping boundary comprising a first last feather edge, a first heel line, a first collar line, a second collar line, a second heel line and a second last feather edge; using the processor to provide a 3D upper, the 3D upper being obtained from a pre-constructed 3D last draft; using the processor to execute a flattening algorithm on the 3D upper with respect to the 2D mapping boundary, and constructing a mapping relation between the 3D upper and the 2D mapping boundary at the same time; using the processor to construct a 2D upper boundary, a portion of the 2D upper boundary comprising a medial bottom line, a lateral bottom line, the first heel line, the first collar line, a second heel line and the second collar line; using the processor to create an upper design drawing on the 2D upper boundary, and to create a 2D upper design area which is formed by the intersection of the 2D upper boundary with an upper design drawing on it, and the 2D mapping boundary; and using the processor to map grids in the 2D upper design area onto grids in the 3D upper via the mapping relation, thereby obtaining an upper design model containing the mapping relation between the 2D upper design area and the 3D upper.

In addition, one preferred embodiment the present invention provides a shoe upper design model generating system, comprising a memory for storing one or a plurality of computer programs comprising a plurality of commands; a processor for executing the plurality of commands in order to execute the following operations: using a processor to provide a 2D mapping boundary, the 2D mapping boundary comprising a first last feather edge, a first heel line, a first collar line, a second collar line, a second heel line and a second last feather edge; using the processor to provide a 3D upper, the 3D upper being obtained from a pre-constructed 3D last draft; using the processor to execute a flattening algorithm on the 3D upper with respect to the 2D mapping boundary, and constructing a mapping relation between the 3D upper and the 2D mapping boundary at the same time; using the processor to construct a 2D upper boundary, a portion of the 2D upper boundary comprising a medial bottom line, a lateral bottom line, the first heel line, the first collar line, a second heel line and the second collar line; using the processor to create an upper design drawing on the 2D upper boundary, and to create a 2D upper design area which is formed by the intersection of the 2D upper boundary with an upper design drawing on it, and the 2D mapping boundary; and using the processor to map grids in the 2D upper design area onto grids in the 3D upper via the mapping relation, thereby obtaining an upper design model containing the mapping relation between the 2D upper design area and the 3D upper.

Furthermore, one preferred embodiment of the present invention provides a non-transitory computer readable storage media, for storing one or a plurality of computer programs comprising a plurality of commands, a processor for executing the plurality of commands, and when the processor executing the plurality of commands, the processor executing the following operations: using a processor to provide a 2D mapping boundary, the 2D mapping boundary comprising a first last feather edge, a first heel line, a first collar line, a second collar line, a second heel line and a second last feather edge; using the processor to provide a 3D upper, the 3D upper being obtained from a pre-constructed 3D last draft; using the processor to execute a flattening algorithm on the 3D upper with respect to the 2D mapping boundary, and constructing a mapping relation between the 3D upper and the 2D mapping boundary at the same time; using the processor to construct a 2D upper boundary, a portion of the 2D upper boundary comprising a medial bottom line, a lateral bottom line, the first heel line, the first collar line, the second heel line and the second collar line; using the processor to create an upper design drawing on the 2D upper boundary, and to create a 2D upper design area which is formed by the intersection of the 2D upper boundary with an upper design drawing on it, and the 2D mapping boundary; and using the processor to map grids in the 2D upper design area onto grids in the 3D upper via the mapping relation, thereby obtaining an upper design model containing the mapping relation between the 2D upper design area and the 3D upper.

Through the aforementioned steps and according to the shoe upper design model generating method, system and non-transitory computer readable storage media provided by the present invention, the designer and pattern maker are able to engage in communication operation during the pattern creation process via the upper design model, in order to effectively reduce the upper pattern making time and cost. In addition, the 3D upper which is on the basis of the complete 2D mapping boundary, along with the application of physical shoe data, then flattens via the flattening algorithm that can preserve the shape. Accordingly, distortion and deformation can be effectively reduced, allowing the completed 2D upper design drawing to be used for production directly.

### BRIEF DESCRIPTION OF THE SEVERAL VIEWS OF THE DRAWINGS

FIG. 1 shows a block diagram of the shoe upper design model generating system according to one preferred embodiment of the present invention;

FIG. 2 shows a flow chart of the shoe upper design model generating method according to one preferred embodiment of the present invention; and

FIG. 3 to FIG. 15 respectively show the schematic view of one of the steps of the shoe upper design model generating method, system or non-transitory computer readable storage media according to one preferred embodiment of the present invention.

### DETAILED DESCRIPTION OF THE INVENTION

The following provides detailed description of the shoe upper design model generating method, system or non-transitory computer readable storage media according to several embodiments of the present invention in conjunction with the accompanied drawings. In addition, identical components and elements are indicated in the same reference numerals for the description.

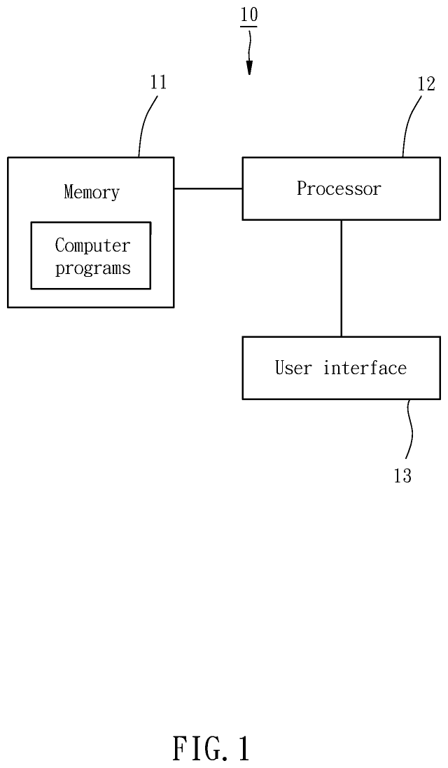

As shown in FIG. 1, a shoe design model generating system 10 comprises a memory 11, a processor 12 and a user interface 13. The memory 11 is electrically connected to the processor 12, and the processor 12 generates the user interface 13. In addition, the memory 11 can be a non-transitory computer readable media, such as read-only memory, flash memory, hard disk, optical disk, portable disk, network database or other storage media, for storing one or a plurality of computer programs comprising a plurality of commands. The processor 12 can be a central processor or a microprocessor. The user interface 13 is provided to allow the user to operate the computer program stored in the memory 11 via the processor 12, and it can be operated in conjunction with a keyboard, a mouse, a touch panel, or a touch panel installed on the mobile electronic device (such as mobile phone, tablet) or similar device. The present invention is not limited to the illustrated examples only.

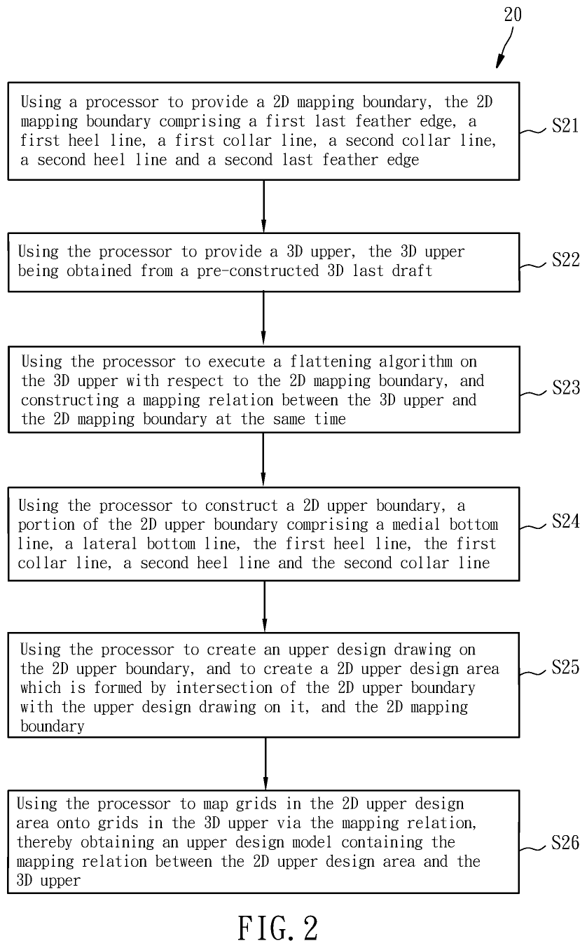

In addition, please refer to FIG. 1 and FIG. 2. When the memory 11 stores one or a plurality of computer programs comprising a plurality of commands, the processor 12 is used to execute these commands stored in the memory 11. When the processor 12 executes these commands, the processor 12 executes the shoe upper design model generating method 20 disclosed in the following, and it comprises Steps S21 to S26. Details of the steps are described in the following.

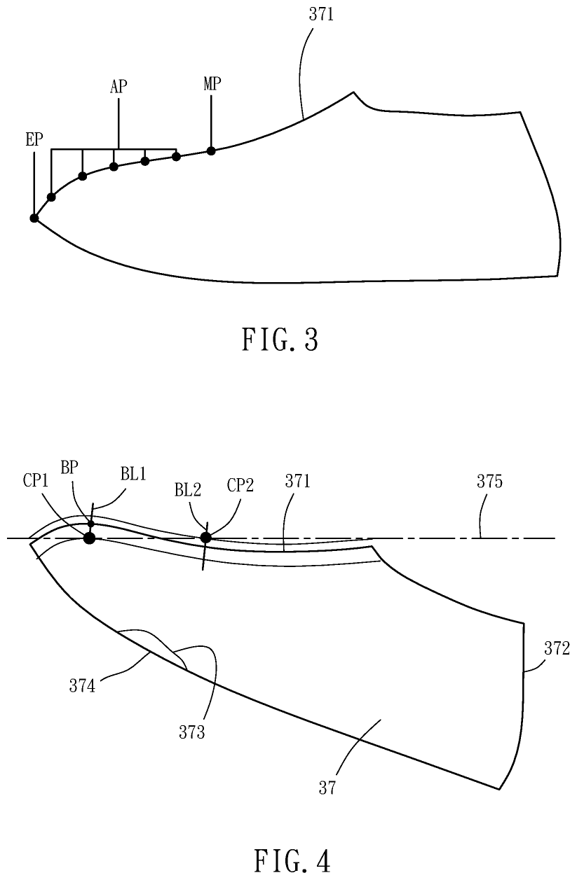

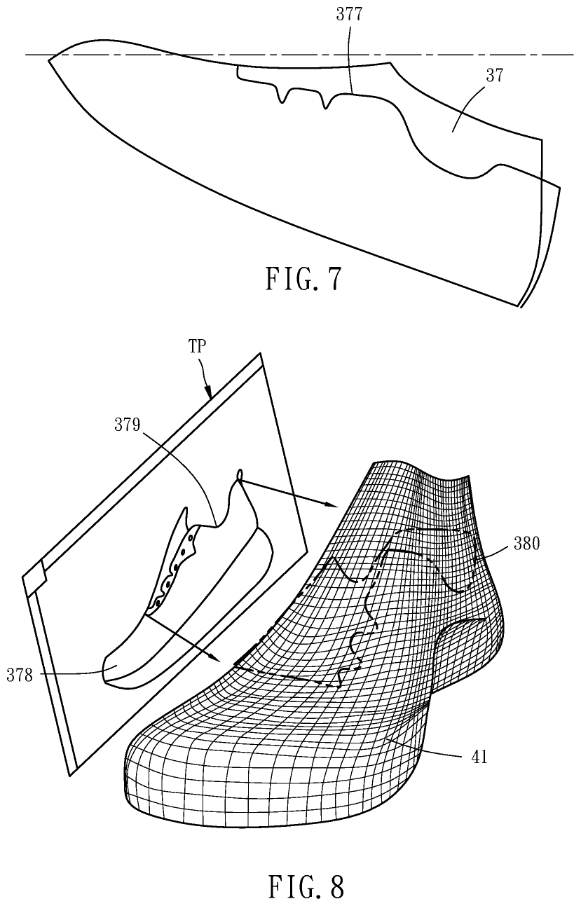

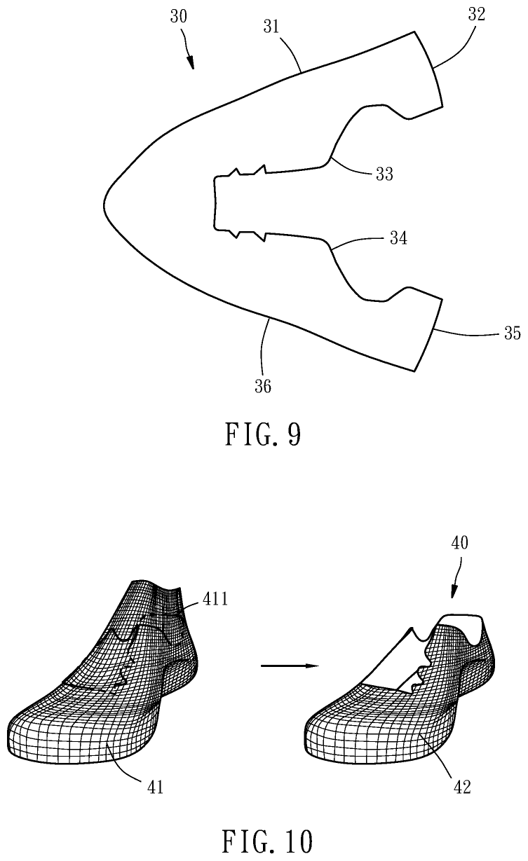

Please refer to FIG. 3 to FIG. 9. In Step S21, the processor 12 is used to provide a 2D mapping boundary 30, the 2D mapping boundary 30 comprises a first last feather edge 31, a first heel line 32, a first collar line 33, a second collar line 34, a second heel line 35 and a second last feather edge 36, as shown in FIG. 9.

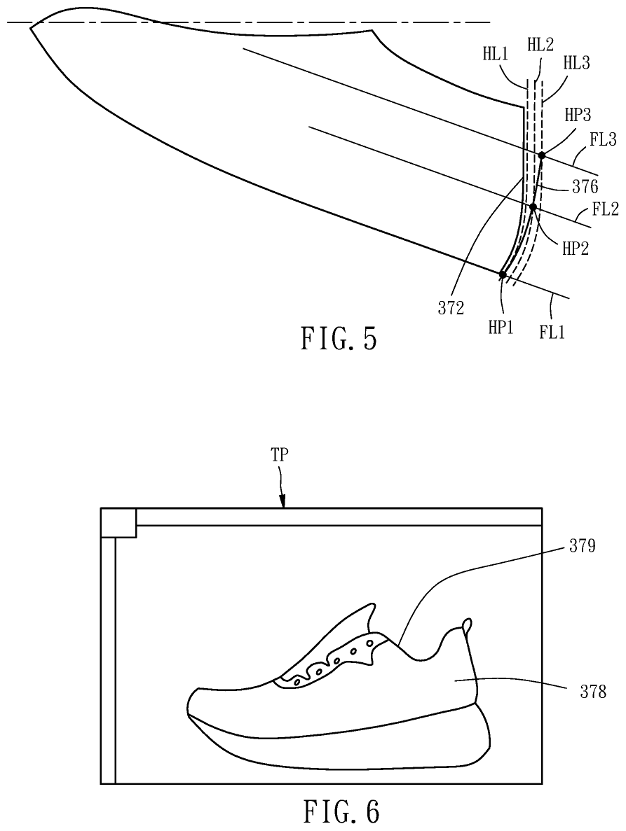

Step S21 further comprises the following steps. In Step S211, the processor 12 is used to provide a 2D last draft 37 after being centered and merged. The 2D last draft 37 includes a front centerline 371, a heel centerline 372, a medial feather edge 373 and a lateral feather edge 374. In Step S212, the processor 12 is used to obtain a middle point MP of the front centerline 371 and an end point EP of the front centerline 371. A plurality of reference points AP arranged in a uniform spacing between the middle point MP and the end point EP are obtained, and the quantity of the reference points AP is greater than 3, as shown in FIG. 3. Then, for each reference point AP, a plurality of tangent vectors of the point and the front centerline 371 are obtained. The quantity of the tangent vectors is the same as the quantity of the reference points AP. Next, the average tangent vector of the tangent vectors is obtained, and the angle of the rotation from the average tangent vector to the horizontal vector is calculated. The 2D last draft 37 is rotated according to such angle, such that the 2D last draft 37 is rotated to the position of the instep facing upward, as shown in FIG. 4. In addition, the 2D last draft 37 can be a predefined specification or can be a customized specification with adjustment. In this embodiment, the quantity of the reference points AP is 5. In Step 213, the processor 12 is used to generate a mirror centerline 375. To be more specific, a tip point BP is specified on the properly rotated and placed 2D last draft 37. A first instep reference line BL1 extends vertically from the tip point BP, and after horizontal extension and displacement of a distance of 60-75 millimeters (mm) from the tip point BP toward the top of the last draft, a second instep reference line BL2 is set up. The second instep reference line BL2 is parallel to the first instep reference line BL1. Finally, after the front centerline 371 is duplicated, it is displaced vertically downward by 1-15 mm to intersect with the first instep reference line BL1 in order to generate a first centerline reference point CP1. Next, after the front centerline 371 is duplicated, it is displaced vertically upward by 1.5-3 mm to intersect with the second instep reference line BL2 in order to generate a second centerline reference point CP2. An extension segment formed by connecting the first centerline reference point CP1 and the second centerline reference point CP2 is the mirror centerline 375, as shown in FIG. 4. In Step S214, the processor 12 is used to generate a heel line 376. To be more specific, the heel centerline 372 is duplicated first, and it is offset outward by 0-2 mm in order to generate a first heel reference line HL1. After the heel centerline 372 is duplicated, it is offset outward by 0-3 mm to generate a second heel reference line HL2. After the heel centerline 372 is duplicated, it is offset outward by 3-8 mm to generate a third heel reference line HL3. The overlapping segment of the medial feather edge 373 and the lateral feather edge 374 is used to extend outward in order to generate a first straight line FL1. Then, the first straight line FL1 is duplicated and is further offset horizontally upward by 43-46 mm to generate a second straight line FL2. Next, the first straight line FL1 is duplicated and is further offset horizontally upward by 80-90 mm to generate a third straight line FL3. The first heel reference line HL1 intersects with the first straight line FL1 to generate a first heel line reference point HP1. The second heel reference line HL2 intersects with the second straight line FL2 to generate a second heel line reference point HP2. The third heel reference line HL3 intersects with the third straight line FL3 to generate a third heel line reference point HP3. Finally, the first heel line reference point HP1, the second heel line reference point HP2 and the third heel line reference point HP3 are connected to generate the heel line 376, as shown in FIG. 5. During actual operation, the actual values of the aforementioned offset can be calculated and obtained according to the parameters indicated in the design drawing and the thickness of the material used. In Step S215, the processor 12 is used, and according to a technical package TP, the technical package TP referring to the 2D design drawing of perspective view or parallel projection view provided by the designer, a 2D collar line 377 is generated directly on the 2D last draft 37 to have a segment direction identical to the collar line in the technical package TP, or is generated by mapping a 3D projection collar line 380 onto the 2D last draft 37, the 3D projection collar line 380 is generated by projecting a 2D simulation collar line 379 onto a pre-constructed 3D last draft 41, and the 2D simulation collar line 379 is generated from a parallel projection view of the 2D design drawing 378 in the technical package TP, as shown in FIGS. 6, 7 and 8. In Step S216, the processor 12 is used to mirror the medial feather edge 373, the heel line 376 and the 2D collar line 377 by the mirror centerline 375, then connecting each segment, in order to generate the 2D mapping boundary 30, as shown in FIG. 9.

In Step S22, the processor 12 is used to provide a 3D upper 40, the 3D upper 40 is obtained from a pre-constructed 3D last draft 41. In addition, the 3D last draft 41 and the previous 2D last draft 37 shares the same last.

Step S22 further comprises the following steps. In Step S221, the processor 12 is used to generate a 3D collar line 411 on the 3D last draft 41 directly based on a technical package TP, or to map the 2D collar line 377 generated in Step S215 onto the 3D last draft 41, in order to generate the 3D collar line 411. In Step 222, the processor 12 is used to cut a 3D last draft 41 surface in order to generate a post-cutting 3D last draft 42. Finally, in Step 223, the processor 12 is used to apply a physical shoe data provided by the commissioning manufacturer to perform shaping of the post-cutting 3D last draft 42 in order to generate the 3D upper 40, as shown in FIG. 10.

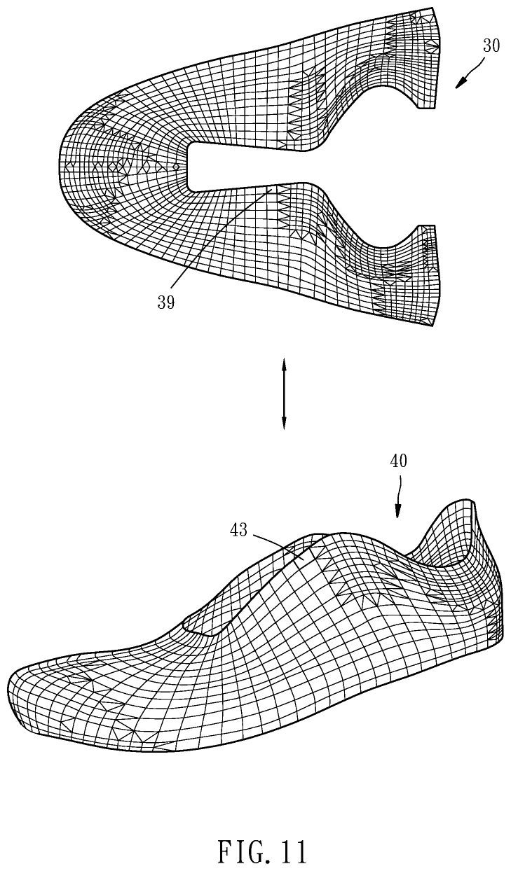

In Step S23, the processor 12 is used to execute a flattening algorithm on the 3D upper 40 with respect to the 2D mapping boundary 30, and a mapping relation is constructed between the 3D upper 40 and the 2D mapping boundary 30 at the same time. In addition, the flattening algorithm can be selected from any one of an Angle-Based Flattening (ABF), a Least Squares Conformal Maps (LSCM) and an As-Rigid-As-Possible Surface Parameterization (ARAP); however, it can also be any type of flattening algorithm such that it is not limited to the aforementioned flattening algorithms only. Under the premise that to preserve each single grid shape as much as possible, the 2D mapping boundary 30 is used as the constraint of the flattening algorithm, and mapping relation is constructed during the computation process at the same time. The 3D unit grids 43 in the 3D upper 40 are flattened to the 2D mapping boundary 30 such that the quantity and layout of the 2D unit grids 39 are consistent with the 3D unit grids 43. The mapping relation refers to that the content of each 3D unit grid 43 on the 3D upper 40 is able to interlink correspondingly with each 2D unit grid 39 on the 2D mapping boundary 30, as shown in FIG. 11.

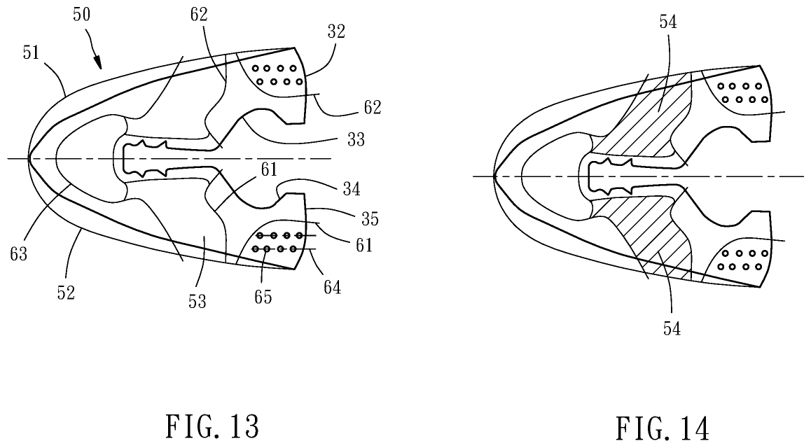

In Step S24, the processor 12 is used to construct a 2D upper boundary 50, a portion of the 2D upper boundary 50 comprises a medial bottom line 51, a lateral bottom line 52, the first heel line 32, the first collar line 33, the second heel line 35 and the second collar line 36, as shown in FIG. 13.

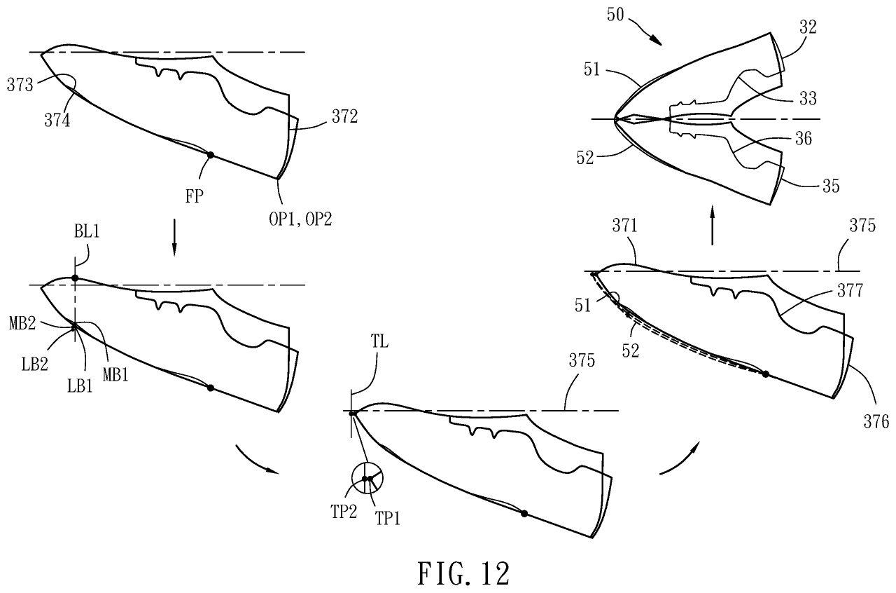

Step S24 further comprises the following steps. In Step S241, the processor 12 is used to construct a first intersection point OP1 for an intersection between the medial feather edge 373 and the heel centerline 372, and to construct a second intersection point OP2 for an intersection between the lateral feather edge 374 and the heel centerline 372. The positions of the two points of first intersection point OP1 and the second intersection point OP2 overlap with each other. The first intersection point OP1 and the second intersection point OP2 are used as starting points to respectively construct a feather edge separation point FP which is a non-overlapping starting point of the medial feather edge 373 and the lateral feather edge 374 along a direction toward the toe. In Step 242, the processor 12 is used to construct a medial feather edge point MB1 for an intersection between the first instep reference line BL1 and the medial feather edge 373, and to construct a lateral feather edge point LB1 for an intersection between the first instep reference line BL1 and the lateral feather edge 374. In Step S243, the processor 12 is used to offset the tangent vector 5-8 mm outward from the medial feather edge point MB1 to construct a medial feather edge reference point MB2, and to offset the tangent vector 5-8 mm outward from the lateral feather edge point LB1 to generate a lateral feather edge reference point LB2. In Step S244, the processor 12 is used to offset a toe tip point TP1 5-8 mm outward with respect to a horizontal direction of the mirror centerline 375 in order to construct a toe tip reference point TP2. In Step S244, the processor 12 is used to connect the top tip reference point TP2, the medial feather edge reference point MB2 and the feather edge separation point FP to construct a medial bottom line 51. In addition, the toe tip reference point TP2, the lateral feather edge reference point LB2 and the feather edge separation point FP are connected to construct lateral bottom line 52. Finally, in Step S245, the processor 12 is used to perform mirroring of the heel line 376, the 2D collar line 377 and the medial bottom line 51 with respect to the mirror centerline 375, followed by connecting the segments, in order to generate the 2D upper boundary 50, as shown in FIG. 12. Similarly, the aforementioned offset values can be calculated and obtained according to the parameters indicated in the design drawing and the thickness of the material used.

In Step S25, the processor 12 is used to create an upper design drawing 53 on the 2D upper boundary 50. The 2D upper boundary 50 with the upper design drawing 53 on it, i.e., the outer boundary together with the upper design lines and pattern, and the 2D mapping boundary 30, i.e., the inner boundary, intersect with each other to form a 2D upper design area 60, comprising the upper design drawing 53, the 2D upper boundary 50 (outer boundary together with the upper design lines) and 2D mapping boundary 30 (inner boundary), as shown in FIGS. 13, 14 and 15.

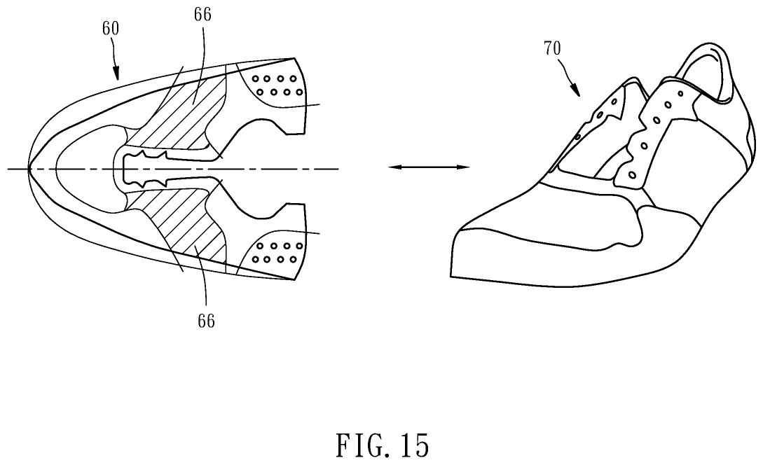

Step S25 further comprises the following steps. In Step S251, the processor 12 is used to create a plurality of design lines on the 2D upper boundary 50, and the design lines comprises base curve 61, mirrored line 62, constrained chain 63, margin 64 and stabs 65. In Step 252, the processor 12 is used to define a plurality of part sections 54 which taking the 2D upper boundary 50 and the plurality of design lines as boundaries. As shown in the example of the area indicated by the oblique lines in FIG. 14, each part section 54 and 2D mapping boundary 30 can be used to generate a design section 66 correspondingly. As shown in the example of the area indicated by the oblique lines in FIG. 15, with the criteria of the edge length of 1-5 mm of the 2D unit grid 39 inside each design section 66, a plurality of design section grids with sufficient density can be generated. Each part section 54 is the basis for subsequent part development, and the result of the part development forms pieces of “part”. In addition, the mapping relation between the plurality of design section grids inside each design section 66 and the corresponding 2D unit grids 39 inside the part section 54 is constructed, such that allowing the plurality of design section grids inside each design section 66 to be mapped onto the 2D unit grids 39 of the 2D upper design area 60, thereby generating indirect mapping relation between each design section grid and each 3D unit grid 43. Consequently, the content in each design section grid is able to interlink with the content in each 3D unit grid 43 correspondingly, as shown in FIGS. 14 and 15.

In Step S26, the processor 12 is used to map grids in the 2D upper design area 60 onto grids in the 3D upper 40 via the mapping relation, thereby obtaining an upper design model 70 containing the mapping relation between the 2D upper design area 60 and the 3D upper 40, as shown in FIG. 15.

Through the aforementioned steps, an upper shoe design model 70 can be constructed, comprising the 2D upper design area 60 equipped with the planar design drawing and the 3D upper 40 with 3D upper design drawing, and the mapping relation between the two are also established. In other words, with the upper design model 70, when the pattern maker makes revision of the planar design drawings on the 2D upper design area 60, such changes can be presented on the 3D upper design drawing of the 3D upper 40 in real time. On the other hand, when the designer makes revision of the 3D upper design drawing on the 3D upper 40, such changes can be presented on the planar design drawings of the 2D upper design area 60 in real time. Furthermore, the 2D upper design area 60 can be further divided into different part sections 54 by the design lines and corresponding design sections 66 can be generated. The mapping relation between the design sections 66 and the 2D upper design area 60 in the part area 54 is also constructed, thereby generating the indirect mapping relation between each design section grid and each 3D unit grid 43, such that the aforementioned modification or change is also interlinked with the design section 66. Accordingly, both the designer and the pattern maker are able to engage in effective communication operation during the pattern making process via the upper design model 70, thus effectively reducing the time and cost of upper pattern making and completing partial pattern parts construction at the same time. Furthermore, during the construction process of the upper design model 70, both the 2D mapping boundary 30 constructed based on the 2D last draft 37 which is identical to the actual last draft, and the 3D upper 40 constructed by the required parameters and material thickness information indicated in the technical package TP plus the physical shoe data are put into the flattening algorithm capable of preserving the grid shape for flattening with respect to the 2D mapping boundary 30. Accordingly, the impact of distortion or deformation during the 2D and 3D conversion process can be effectively reduced, allowing the 2D upper design drawing to be close to the 3D pattern of the original design, and production can be performed according to the completed 2D upper design drawing directly.

It shall be noted that the above provides detailed description of the present invention along with the accompanied drawings to illustrate the technical content and features of the present invention only such that an embodiment of the present invention is provided as an example. For an ordinary person skilled in the art in the technical field of the present invention, after understanding the technical content and features of the present invention, may make simple modification, replacement or omission of components without deviating from the principle of the present invention, which shall be considered to be within the scope of the claims of the present invention.

What is claimed is:

1. A shoe upper design model generating method, comprising the following steps:
using a processor to provide a 2D mapping boundary, the 2D mapping boundary comprising a first last feather edge, a first heel line, a first collar line, a second collar line, a second heel line and a second last feather edge;
using the processor to provide a 3D upper, the 3D upper being obtained from a pre-constructed 3D last draft;
using the processor to execute a flattening algorithm on the 3D upper with respect to the 2D mapping boundary, and constructing a mapping relation between the 3D upper and the 2D mapping boundary at the same time;
using the processor to construct a 2D upper boundary, a portion of the 2D upper boundary comprising a medial bottom line, a lateral bottom line, the first heel line, the first collar line, a second heel line and the second collar line;
using the processor to create an upper design drawing on the 2D upper boundary, and to create a 2D upper design area which is formed by intersection of the 2D upper boundary with the upper design drawing on it, and the 2D mapping boundary; and
using the processor to map grids in the 2D upper design area onto grids in the 3D upper via the mapping relation, thereby obtaining an upper design model containing the mapping relation between the 2D upper design area and the 3D upper.

2. The shoe upper design model generating method according to claim 1, wherein the flattening algorithm is selected from any one of an Angle-Based Flattening (ABF), a Least Squares Conformal Maps (LSCM) and an As-Rigid-As-Possible Surface Parameterization (ARAP).

3. The shoe upper design model generating method according to claim 1, wherein the step of using the processor to provide the 2D mapping boundary further comprises:
using the processor to provide a 2D last draft, the 2D last draft has a front centerline, a heel centerline, a media feather edge and a lateral feather edge;
using the processor to obtain a middle point of the front centerline and an end point of the front centerline, and obtaining a plurality of reference points arranged in a uniform spacing between the two points, and for each one of the reference points, obtaining a plurality of tangent vectors of the point and the front centerline, then obtaining an average tangent vector of the plurality of tangent vectors, calculating the angle of the rotation from the average tangent vector to a horizontal vector, and rotating the 2D last draft to a position of an instep facing upward;
using the processor to generate a mirror centerline;
using the processor to generate a heel line;
using the processor to generate a 2D collar line on the 2D last draft based on a technical package, or generate a 2D collar line by mapping a 3D projection collar line onto the 2D last draft, wherein the 3D projection collar line is generated by projecting a 2D simulation collar line onto a pre-constructed 3D last draft, and the 2D simulation collar line is generated from a parallel projection view of the 2D design drawing in the technical package; and
using the processor to mirror the medial feather edge, the heel line and the 2D collar line by the mirror centerline, then connecting each segment, in order to generate the 2D mapping boundary.

4. The shoe upper design model generating method according to claim 3, wherein the step of using the processor to provide the 3D upper further comprises:
using the processor to generate a 2D collar line directly on the parallel projection view of the 2D design drawing based on the technical package, then projecting the 2D collar line onto a pre-constructed 3D last draft to generate the 3D collar line, or generating the 2D collar line on the 2D last draft based on a technical package, then mapping the 2D collar line onto the 3D last draft in order to generate the 3D collar line;
using the processor to cut a 3D last draft surface in order to generate a post-cutting 3D last draft; and
using the processor to apply a physical shoe data to perform shaping of the post-cutting 3D last draft in order to generate the 3D upper.

5. The shoe upper design model generating method according to claim 4, wherein the step of using the processor to construct a 2D upper boundary further comprises:
using the processor to construct a first intersection point for an intersection of the medial feather edge and the heel centerline, and to construct a second intersection point for an intersection of the lateral feather edge and the heel centerline, and using the first intersection point and the second intersection point as starting points to construct a feather edge separation point which is a non-overlapping starting point of the medial feather edge and the lateral feather edge along a direction toward a toe respectively;
using the processor to construct a medial feather edge point for an intersection between the first instep reference line and the medial feather edge, and to construct an lateral feather edge point for an intersection between the first instep reference line and the lateral feather edge;
using the processor to offset the tangent vector 5-8 millimeters outward from the medial feather edge point to construct a medial feather edge reference point, and offset the tangent vector 5-8 millimeters outward from the lateral feather edge point to generate a lateral feather edge reference point;
using the processor to offset a toe tip point 5-8 millimeters outward with respect to a horizontal direction of the mirror centerline in order to construct a toe tip reference point;
using the processor to connect the toe tip reference point, the medial feather edge reference point and the feather edge separation point in order to construct a medial bottom line, and connect the toe tip reference point, the lateral feather edge reference point and the feather edge separation point in order to construct a lateral bottom line; and
using the processor to perform mirroring of the heel line, the 2D collar line and the medial bottom line based on the mirror centerline, followed by connecting each segment, in order to generate the 2D upper boundary.

6. The shoe upper design model generating method according to claim 1, wherein the step of using the processor to create an upper design drawing on the 2D upper boundary further comprises:
using the processor to create a plurality of design lines on the 2D upper boundary; and
using the processor to define a plurality of part sections which taking the 2D upper boundary and the plurality of design lines as boundaries and generate a plurality of part section grids.

7. The shoe upper design model generating method according to claim 6, wherein each one of the part sections and the 2D mapping boundary being used to generate a design section correspondingly, and to construct a mapping relation between each one of the design sections and the 2D upper design area, thereby allowing each one of the grids in the design section to be mapped onto grids of the 2D upper design area.

8. A shoe upper design model generating system, comprising:
a memory for storing one or a plurality of computer programs comprising a plurality of commands;
a processor for executing the plurality of commands in order to execute the following operations:
using a processor to provide a 2D mapping boundary, the 2D mapping boundary comprising a first last feather edge, a first heel line, a first collar line, a second collar line, a second heel line and a second last feather edge;
using the processor to provide a 3D upper, the 3D upper being obtained from a pre-constructed 3D last draft;
using the processor to execute a flattening algorithm on the 3D upper with respect to the 2D mapping boundary, and constructing a mapping relation between the 3D upper and the 2D mapping boundary at the same time;
using the processor to construct a 2D upper boundary, a portion of the 2D upper boundary comprising a medial bottom line, a lateral bottom line, the first heel line, the first collar line, a second heel line and the second collar line;
using the processor to create an upper design drawing on the 2D upper boundary, and to create a 2D upper design area which is formed by intersection of the 2D upper boundary with the upper design drawing on it, and the 2D mapping boundary; and
using the processor to map grids in the 2D upper design area onto grids in the 3D upper via the mapping relation, thereby obtaining an upper design model containing the mapping relation between the 2D upper design area and the 3D upper.

9. The shoe upper design model generating system according to claim 8, wherein the flattening algorithm is selected from any one of an Angle-Based Flattening (ABF), a Least Squares Conformal Maps (LSCM) and an As-Rigid-As-Possible Surface Parameterization (ARAP).

10. The shoe upper design model generating system according to claim 8, wherein the step of using the processor to provide the 2D mapping boundary further comprises:
using the processor to provide a 2D last draft, the 2D last draft has a front centerline, a heel centerline, a medial feather edge and a lateral feather edge;
using the processor to obtain a middle point of the front centerline and an end point of the front centerline, and obtaining a plurality of reference points arranged in a uniform spacing between the two points, and for each one of the reference points, obtaining a plurality of tangent vectors of the point and the front centerline, then obtaining an average tangent vector of the plurality of tangent vectors, calculating the angle of the rotation from the average tangent vector to a horizontal vector, and rotating the 2D last draft to a position of an instep facing upward;
using the processor to generate a mirror centerline;
using the processor to generate a heel line;
using the processor to generate a 2D collar line on the 2D last draft based on a technical package, or generate a 2D collar line by mapping a 3D projection collar line onto the 2D last draft, wherein the 3D projection collar line is generated by projecting a 2D simulation collar line onto a pre-constructed 3D last draft, and the 2D simulation collar line is generated from a parallel projection view of the 2D design drawing in the technical package; and
using the processor to mirror the medial feather edge, the heel line and the 2D collar line by the mirror centerline, then connecting each segment, in order to generate the 2D mapping boundary.

11. The shoe upper design model generating system according to claim 8, wherein the step of using the processor to provide the 3D upper further comprises:
using the processor to generate a 2D collar line directly on the parallel projection view of the 2D design drawing based on the technical package, then projecting the 2D collar line onto a pre-constructed 3D last draft to generate the 3D collar line, or generating the 2D collar line on the 2D last draft based on a technical package, then mapping the 2D collar line onto the 3D last draft in order to generate the 3D collar line;
using the processor to cut a 3D last draft surface in order to generate a post-cutting 3D last draft; and
using the processor to apply a physical shoe data to perform shaping of the post-cutting 3D last draft in order to generate the 3D upper.

12. The shoe upper design model generating system according to claim 11, wherein the step of using the processor to construct a 2D upper boundary further comprises:
using the processor to construct a first intersection point for an intersection of the medial feather edge and the heel centerline, and to construct a second intersection point for an intersection of the lateral feather edge and the heel centerline, and using the first intersection point and the second intersection point as starting points to respectively construct a feather edge separation point with a non-overlapping starting point of the medial feather edge and the lateral feather edge along a direction toward a toe;
using the processor to construct a medial feather edge point for an intersection between the first instep reference line and the medial feather edge, and to construct a lateral feather edge point for an intersection between the first instep reference line and the lateral feather edge point;
using the processor to offset the tangent vector 5-8 millimeters outward from the medial feather edge point to construct a medial feather edge reference point, and offset a tangent vector 5-8 millimeters outward from the lateral feather edge point to generate a lateral feather edge reference point;
using the processor to offset a toe tip point 5-8 millimeters outward with respect to a horizontal direction of the mirror centerline in order to construct a toe tip reference point;
using the processor to connect the toe tip reference point, the medial feather edge reference point and the feather edge separation point in order to construct a medial bottom line, and connect the toe tip reference point, the lateral feather edge reference point and the feather edge separation point in order to construct a lateral bottom line; and
using the processor to perform mirroring of the heel line, the 2D collar line and the medial bottom line based on the mirror centerline, followed by connecting each segment, in order to generate the 2D upper boundary.

13. The shoe upper design model generating system according to claim 12, wherein the step of using the processor to create an upper design drawing on the 2D upper boundary further comprises:
using the processor to create a plurality of design lines on the 2D upper boundary; and
using the processor to define a plurality of part sections which taking the 2D upper boundary and the plurality of design lines as boundaries and generate a plurality of part section grids.

14. The shoe upper design model generating system according to claim 13, wherein each one of the part sections and the 2D mapping boundary being used to generate a design section correspondingly, and to construct a mapping relation between each one of the design sections and the 2D upper design area, thereby allowing each one of the grids in the design section to be mapped onto grids of the 2D upper design area.

15. A non-transitory computer readable storage media, for storing one or a plurality of computer programs comprising a plurality of commands, a processor for executing the plurality of commands, and when the processor executing the plurality of commands, the processor executing the following operations:
using a processor to provide a 2D mapping boundary, the 2D mapping boundary comprising a first last feather edge, a first heel line, a first collar line, a second collar line, a second heel line and a second last feather edge;
using the processor to provide a 3D upper, the 3D upper being obtained from a pre-constructed 3D last draft;
using the processor to execute a flattening algorithm on the 3D upper with respect to the 2D mapping boundary, and constructing a mapping relation between the 3D upper and the 2D mapping boundary at the same time;
using the processor to construct a 2D upper boundary, a portion of the 2D upper boundary comprising a medial bottom line, a lateral bottom line, the first heel line, the first collar line, the second heel line and the second collar line;
using the processor to create an upper design drawing on the 2D upper boundary, and to create a 2D upper design area which is formed by intersection of the 2D upper boundary with an upper design drawing on it, and the 2D mapping boundary; and
using the processor to map grids in the 2D upper design area onto grids in the 3D upper via the mapping relation, thereby obtaining an upper design model containing the mapping relation between the 2D upper design area and the 3D upper.

16. The non-transitory computer readable storage media according to claim 15, wherein the flattening algorithm is selected from any one of an Angle-Based Flattening (ABF), a Least Squares Conformal Maps (LSCM) and an As-Rigid-As-Possible Surface Parameterization (ARAP).

17. The non-transitory computer readable storage media according to claim 15, wherein the step of using the processor to provide the 2D mapping boundary further comprises:
using the processor to provide a 2D last draft, the 2D last draft has a front centerline, a heel centerline, a medial feather edge and a lateral feather edge;
using the processor to obtain a middle point of the front centerline and an end point of the front centerline, and obtaining a plurality of reference points arranged in a uniform spacing between the two points, and for each one of the reference points, obtaining a plurality of tangent vectors of the point and the front centerline, then obtaining an average tangent vector of the plurality of tangent vectors, calculating the angle of the rotation from the average tangent vector to a horizontal vector, and rotating the 2D last draft to a position of an instep facing upward;
using the processor to generate a mirror centerline;
using the processor to generate a heel line;
using the processor to generate a 2D collar line on the 2D last draft based on a technical package, or generate a 2D collar line by mapping a 3D projection collar line onto the 2D last draft, wherein the 3D projection collar line is generated by projecting a 2D simulation collar line onto a pre-constructed 3D last draft, and the 2D simulation collar line is generated from a parallel projection view of the 2D design drawing in the technical package; and
using the processor to mirror the medial feather edge, the heel line and the 2D collar line by the mirror centerline, then connecting each segment, in order to generate the 2D mapping boundary.

18. The non-transitory computer readable storage media according to claim 17, wherein the step of using the processor to provide to the 3D upper further comprises:
using the processor to generate a 2D collar line directly on the parallel projection view of the 2D design drawing based on the technical package, then projecting the 2D collar line onto a pre-constructed 3D last draft to generate the 3D collar line, or generating the 2D collar line on the 2D last draft based on a technical package, then mapping the 2D collar line onto the 3D last draft in order to generate the 3D collar line;
using the processor to cut a 3D last draft surface in order to generate a post-cutting 3D last draft; and
using the processor to apply a physical shoe data to perform shaping of the post-cutting 3D last draft in order to generate the 3D upper.

19. The non-transitory computer readable storage media according to claim 18, wherein the step of using the processor to construct a 2D upper boundary further comprises:
using the processor to construct a first intersection point for an intersection between the medial feather edge and the heel centerline, and construct a second intersection point for an intersection between the lateral feather edge and the heel centerline, and using the first intersection point and the second intersection point as starting points to respectively construct a feather edge separation point which is a non-overlapping starting point of the medial feather edge and the lateral feather edge along a direction toward a toe;
using the processor to construct a medial feather edge point for an intersection between the first instep reference line and the medial feather edge, and to construct a lateral feather edge point for an intersection between the first instep reference line and the lateral feather edge point;
using the processor to offset the tangent vector 5-8 millimeters outward from the medial feather edge point to construct a medial feather edge reference point, and offset the tangent vector 5-8 millimeters outward from the lateral feather edge point to generate a lateral feather edge reference point;
using the processor to offset a toe tip point 5-8 millimeters outward with respect to a horizontal direction of the mirror centerline in order to construct a toe tip reference point;
using the processor to connect the toe tip reference point, the medial feather edge reference point and the feather edge separation point in order to construct a medial bottom line, and connect the toe tip reference point, the lateral feather edge reference point and the feather edge separation point in order to construct a lateral bottom line; and
using the processor to perform mirroring of the heel line, the 2D collar line and the medial bottom line based on the mirror centerline, followed by connecting each segment, in order to generate the 2D upper boundary.

20. The non-transitory computer readable storage media according to claim 15, wherein the step of using the processor to create an upper design drawing on the 2D upper boundary further comprises:
using the processor to create a plurality of design lines on the 2D upper boundary; and
using the processor to define a plurality of part sections with the 2D upper boundary and the plurality of design lines as boundaries and generate a plurality of part section grids.

21. The shoe upper design model generating system according to claim 20, wherein each one of the part sections and the 2D mapping boundary being used to generate a design section correspondingly, and to construct a mapping relation between each one of the design sections and the 2D upper design area, thereby allowing each one of the grids in the design section to be mapped onto grids of the 2D upper design area.
